(19) United States
(12) Patent Application Publication
(10) Pub. No.: US 2011/0113832 A1
(43) Pub. Date: May 19, 2011

(54) FRICTION DAMPER DEVICE FOR A WASHING MACHINE

(75) Inventors: Uwe Ackermann, Schonwalde-Glien (DE); Andreas Bohm, Berlin (DE); Rolf Schuck, New Bern, NC (US)

(73) Assignee: BSH BOSCH UND SIEMENS HAUSGERATE GmbH, Munich (DE)

(21) Appl. No.: 13/010,969

(22) Filed: Jan. 21, 2011

Related U.S. Application Data
(62) Division of application No. 11/664,225, filed on Feb. 27, 2008.

(30) Foreign Application Priority Data
Oct. 1, 2004 (DE) 102004047999.2

(51) Int. Cl. D06F 35/00; F16F 7/09

(52) U.S. Cl. 68/23.1; 188/381

(57) ABSTRACT

A washing machine contains a friction damper device for a washing unit comprising a tub, a washing drum which is rotationally mounted in the tub and a drive for the washing drum. The washing unit is supported in an elastic manner by at least one damper counter to a lower frame part of the housing. In order to prevent the vibratory behavior of the oscillating unit from being influenced above the rotational speed of the resonance, the friction in the damper above the rotational speed of the resonance can be reduced. As a result, at least one friction covering which interacts directly on a piston rod of the damper is pretensed by an energy store counter to the piston rod and can be displaced away from the piston rod by activating an actuator.

### CROSS REFERENCE TO RELATED APPLICATIONS

This application is a Divisional, under 35 U.S.C. §121, of U.S. application Ser. No. 11/664,225, filed Feb. 27, 2008, which is a U.S. National Stage Application of International Application No. PCT/EP05/054958, filed Sep. 30, 2005, which designated the United States; this application also claims the priority, under 35 U.S.C. §119, of German Patent Application No. 10 2004 047 999.2, filed Oct. 1, 2004.

### BACKGROUND OF THE INVENTION

This invention relates to a friction damper device for a washing machine in whose housing is arranged a washing unit with a tub, a washing drum which is rotationally mounted in the tub and a drive for the washing drum, the washing unit being supported in an elastic manner by at least one damper counter to the lower frame part of the housing.

In connection with washing machines different systems are known for mounting the washing unit, which includes of a tub, a drive for the tub and a washing drum. In so-called upright systems the washing unit is normally supported in an elastic manner by a plurality of spring legs relative to a lower frame part of the housing of the washing machine. In so-called suspended systems, i.e. mixed systems, the washing unit is suspended at a plurality of points on an upper frame part of the housing by means of springs and is mounted so that the vibrations are damped by means of dampers in respect of a lower frame part of the housing.

DE 30 43 550 C2 discloses a fully automatic drum washing machine designed for spinning, whose washing unit is supported on the machine base with sprung, damping spring legs. Each spring leg is fastened to the housing frame of the washing machine at its lower end by means of two rubber rounds between which is clamped a base plate of the housing frame. Upwardly directed forces are transmitted to the upper rubber round and downwardly directed forces are transmitted to the lower rubber round.

DE 36 26 065 C2 describes a friction damper device for a washing machine whose washing unit is freely suspended on the housing by means of tension springs. Between the tub and base plate of the washing machine are provided friction damper devices whose task is to damp unbalancing vibrations of the washing unit during the operation of the washing machine, particularly when passing through the critical speed, when the washing drum is accelerated from a low washing speed to a high spinning speed. For this purpose each friction damper device has a friction plate fastened to the tub against which friction linings of friction heads are pushed in pairs on opposite sides, which heads are each fastened to an arm of a clamping or retaining strap. A motor friction switch, which is able to push the friction heads against the pre-tension force of the clamping and retaining straps, grips the arms of the clamping and retaining straps which normally press the friction linings against the friction plate. The friction switch is designed as a piston/cylinder drive that can be loaded with a pressure fluid. Alternatively the friction switch may comprise an electric motor and an adjusting spindle. The damping forces of the friction damper device can therefore be increased after the critical speed is passed.

### SUMMARY OF THE INVENTION

The object of this invention includes providing a friction damper device that is of relatively simple construction and guarantees safe operation of the washing machine.

This object is achieved by a friction damper device for a washing machine with the features of described in the claims. Advantageous designs of the invention are also described in the dependent claims.

Another advantage includes the fact that the present friction damper device is of relatively simple construction and is therefore inexpensive. A further advantage of the invention includes the fact that in the event of a sudden power failure, for example if the washing machine is accidentally switched off during its operation, the friction damper device according to the invention regains its damping force immediately and automatically, thereby guaranteeing safe “passage” through the lower speed range until the machine stops. The present friction damper device can, in particularly, be effectively switched in a speed range of the washing drum from approximately 0 to 300 rpm, which also includes the resonance range for the spinning acceleration. Above this range, i.e. during spinning, the damper forces do not affect the oscillating behavior of the washing unit, which is why the present friction damper device can be either completely switched off electrically or switched so that its damping force is reduced, thereby considerably improving the oscillating behavior of the entire washing machine. In particular, the vibratory behavior of the entire appliance is improved and noises are reduced.

The present friction damper device is switched so that its damping effect is restored when the upper spinning speed range is departed from.

The present friction damper device can be used for upright and suspended systems, as well as in mixed systems.

### BRIEF DESCRIPTION OF THE DRAWINGS

The invention is explained in greater detail in the following with reference to the drawing in which advantageous exemplary embodiments are represented.

FIG. 1 shows in a diagrammatic view an explanatory representation of a possible suspension of the washing unit of a washing machine,

FIG. 2 shows a side view of the friction damper device according to the invention,

FIG. 3 shows a section through the friction damper device according to the invention along line in FIG. 2,

FIG. 4 shows a further embodiment of the friction damper device according to the invention,

FIG. 5 shows a section along line V-V of the embodiment of the friction damper device according to the invention shown in FIG. 4, and

FIG. 6 shows a further development of the embodiment of the friction damper device according to the invention shown in FIG. 4.

### DETAILED DESCRIPTION OF THE EXEMPLARY EMBODIMENTS OF THE PRESENT INVENTION

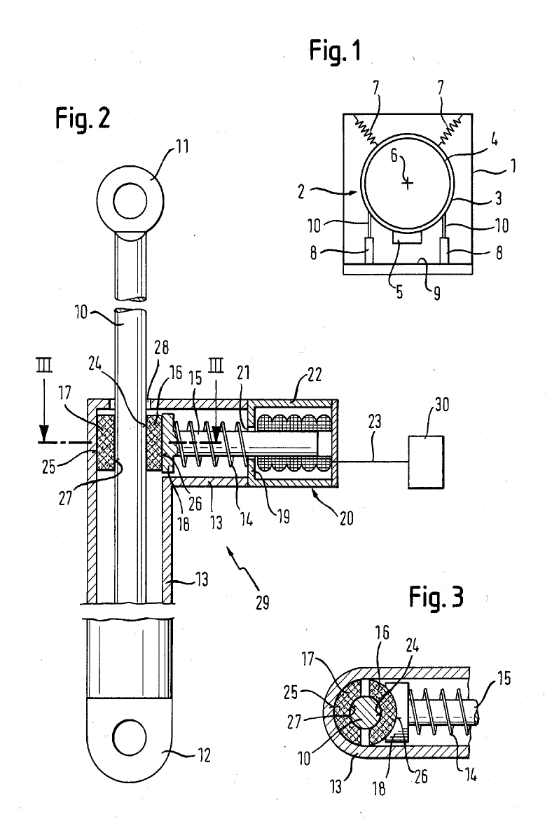

According to FIG. 1 washing unit 2 of a washing machine of prior art, arranged in a housing 1, comprises a tub 3, a washing drum 4 and a drive 5 arranged on tub 3, which drive rotates washing drum 3 about a horizontal axis 6. Washing unit 2 can be suspended preferably directly on an upper frame of housing 1 by means of tension springs 7, shown diagrammatically. In order to damp the vibrations that are generated during washing and spinning of the items to be washed in washing drum 4, dampers 8, which are supported on the one hand on washing unit 2 and on the other on a lower frame part 9 of housing 1, are provided on tub 3. The piston rods of dampers 8 are denoted by 10.

In order to compensate selectively for any unbalance, which is necessary particularly in a speed range of approximately 0 to 300 rpm, because this range includes the resonance range for the spinning acceleration, this invention provides a friction damper device 29 whose damping force can be switched or controlled electrically. Since the damping forces would disturb the oscillating behavior of washing unit 2 above the above-mentioned speed range, the damping force of this friction damper device 29 can be switched or reduced quite effectively above this range so that the oscillating and vibratory behavior of the entire washing machine is considerably improved and the noise generated is reduced in this upper speed range. When the upper speed range is again departed from after spinning, the damping force of this friction damper device 29 is restored. Since this friction damper device 29 is switched or controlled electrically against the force of a compression spring 14, as will be explained in greater detail below, it is possible for friction damper device 29 to retain its damping force immediately and automatically after a sudden power failure, for example if the washing machine is accidentally switched of, thereby guaranteeing safe passage through the lower speed range until the machine stops.

FIG. 2 shows a preferred embodiment of this friction damper device 29. It comprises essentially, and in a known manner, a piston rod 10 of a damper 8, which is articulated with its upper end 11 to washing unit 2 and with its lower end 12 to a lower frame part 9 of housing 1. A cylindrical housing part 13 that at least partially surrounds piston rod 10 incorporates a slide 15, which suitably runs transversely to piston rod 10 and which preferably has a shoulder part 18, which is preferably plate-shaped, on its side facing piston rod 10, to which part is fastened a friction lining 16. Between shoulder part 18 and a stop part 19 is arranged an energy store on the side of shoulder part 18 facing away from piston rod 10, which store preferably takes the form of a helical compression spring 14 surrounding slide 15, which spring is supported on one side on shoulder part 18 and on the other side on stop part 19, so that shoulder part 18 presses with friction lining 16 against piston rod 10.

According to FIG. 3 friction lining 16 is preferably designed in an annular shape so that it bears with its friction surface 24 partially and suitably flush against the peripheral surface of piston ring 10, which has the shape of a regular cylinder, when compression spring 14 exerts its effect. Friction lining 16 is preferably fastened, preferably glued, in a circular recess 26 of shoulder part 18. Friction lining 16 is preferably designed so that it is able to engage on half the peripheral surface of piston rod 10.

A further friction lining 17, which is preferably also annular in shape, is located on the side of piston rod 10 opposite friction lining 16, so that lining 17 bears partially, and preferably flush with its friction surface 27 against the peripheral surface of piston rod 10, its side facing away from piston rod 10 being preferably fastened, in particular glued, to an inner wall 25 of housing part 13 also running in a circular course.

Slide 15 can be actuated by an electromagnetic actuator 20 against the force of compression spring 14, in the manner shown in FIG. 2, so that shoulder part 18 is moved with friction lining 16 away from piston rod 10 when actuator 20 is energized so that piston rod 10 is able to oscillate freely. Electromagnetic actuator 20 is located in a housing part 22 which preferably has an end face forming stop part 19, which end face has an opening 21 through which slide 15 runs, housing part 22 being fastened to housing part 13. The electrical cable serving to supply power to actuator 20 is shown diagrammatically and is denoted by 23.

Friction damper device 29 previously described operates in the following manner. Actuator 20 is energized in the lower speed range from approximately 0 to 300 rpm of washing drum 4 so that compression spring 14 exerts its full effect and presses friction lining 16 against piston rod 10 so that the latter is retained between friction linings 16 and 17 by friction in a damping manner and an action that damps the vibrations of washing unit 2 is exerted.

If no damping action is to be exerted in a higher speed range, i.e. in the spinning range, electromagnetic actuator 20 is energized so that friction lining 16 is pulled away from piston rod 10 by a movement of slide 15 against the force of compression spring 14. Piston rod 10 is not then damped. As soon as electromagnetic actuator 20 is de-energized, slide 15 is released and compression spring 14 again presses friction lining 16 against piston rod 10.

It is pointed out that other “pulling” or “pushing” electromagnetic actuators with associated compression or tension springs may also be used instead of electromagnetic actuator 20 described above, which generates a force “pulling” slide 15 when energized, provided that these springs operate in the manner explained above.

Instead of the switching off and on of actuator 20, explained above, where the conditions “damping of the piston rod” or “non-damping of the piston rod” are reached, it is also conceivable to activate electromagnetic actuator 20 by means of a control unit 30 so that the compressive force of compression spring 14 is increased by a predetermined movement of slide 15 to a desired extent in order to achieve a desired greater or smaller damping force on piston rod 10. In other words, a predetermined damping profile can be set by the specific activation of electromagnetic actuator 20 by control unit 30 as a function of the current speed of washing drum 2.

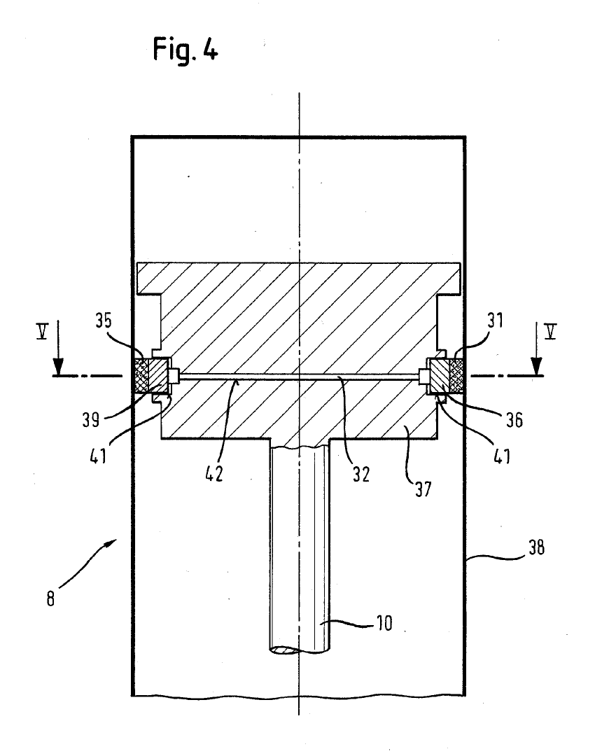

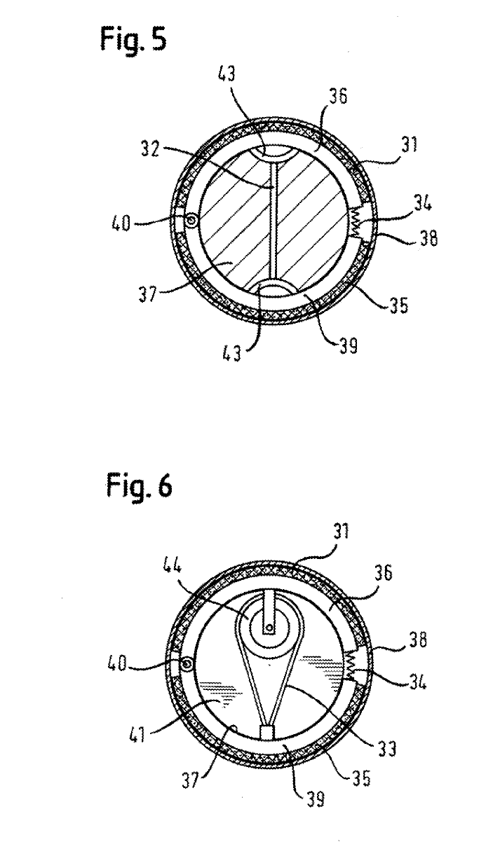

A further embodiment of this friction damper device is explained in the following with reference to FIGS. 4 and 5, where friction lining 31 is arranged on the periphery of a piston 37 arranged in a cylinder 38 of damper 8 and connected to piston rod 10, and is pretensed by an energy store counter to the inner wall of cylinder 38. An actuator is able to displace a friction lining 31 away from the inner wall of cylinder 38 during is activation against the pretension of the energy store.

The actuator is preferably a memory metal part 32 arranged on piston 37, which part, when energized, generates a force which pulls or moves friction lining 31, pretensed by the energy store counter to the inner wall of cylinder 38, away from the inner wall. The damping effect of damper 8 is increased here. Friction lining 31 is suitably fastened, in particular glued, to a support part 36.

The memory metal part can be energized in various ways. The introduction of thermal energy may be preferably provided for this purpose.

In particular, a further friction lining 35 is preferably fastened, preferably glued, to a further support part 39 on piston 37, which part is connected to support part 36 so that it is able to rotate about a fulcrum 40. Support part 36 and further support part 39 run at least partially around the periphery of piston 37 and engages in a peripheral groove 41 (FIG. 4) on its side facing towards piston 37. Memory metal part 32 is designed in the shape of a rod and runs through a through opening 42 leading transversely through piston 37. It is fastened with its one end to support part 36 and with its other end to further support part 39. The fastening is preferably effected by means of retaining parts 43 which enable a force that is particularly favorable to be introduced over a large area into support part 36 and 39 respectively. The end regions of support part 36 and further support part 39 facing away from fulcrum 40 are connected to one another by a recuperating spring 34 forming the energy store. Recuperating spring 34 presses the aforementioned end regions apart towards the inner wall of cylinder 38 so that friction lining 31 and further friction lining 35 bear against the inner wall of cylinder 38. Rod-shaped memory metal part 32 is formed in particular preference by a metal wire.

FIG. 6 shows a further embodiment of this friction damper device. Details of FIG. 6, which have already been explained with reference to FIGS. 4 and 5, are denoted by corresponding numbers. In this case the actuator is a memory wire 33, which is formed into a loop and, when energized, reduces the circumference of the loop. The loop runs around a roll 44 arranged in a cavity 41 of piston 37 and fastened to support part 36. The loop is fastened to further support part 39 on the side opposite roll 44, and the end regions of support part 36 and further support part 39 facing away from fulcrum 40 are spread apart by recuperating spring 34. This ensures that the force of recuperating spring 34 pretenses support parts 36 and 39 with friction linings 31 and 35 respectively counter to the inner wall of cylinder 38, and that friction linings 31 and 35 are pulled away from the inner wall when memory part 32 is energized.

What is claimed is:

1. A friction damper device for a washing machine in whose housing is arranged a washing unit with a tub, a washing drum rotationally mounted in the tub and a drive for the washing drum, wherein the washing unit is supported by at least one damper, which includes a piston and piston rod arranged in a cylinder, in an elastic manner against a lower frame part of the housing, the friction damper device comprising:
at least one friction lining acting directly on an inner wall of the cylinder of the damper, wherein the at least one friction lining is pretensed counter to the inner wall of the cylinder of the damper by an energy store and can be displaced away from the inner wall of the cylinder by activating an actuator.

2. The friction damper device of claim 1, wherein the at least one friction lining is fastened to a support part which is arranged on a periphery of the piston arranged in the cylinder of the damper and connected to the piston rod, and
wherein the actuator, when activated, displaces the support part and the friction lining away from the inner wall of the cylinder against the pretension of the energy store.

3. The friction damper device of claim 2, wherein the actuator is a memory metal part arranged on the piston, which part, when energized mechanically, generates the force that moves the friction lining away from the inner wall.

4. The friction damper device of claim 2, wherein the energy store has a recuperating spring that pretenses the support part and the friction lining to the inner wall of the cylinder.

5. The friction damper device of claim 3, wherein a second friction lining is provided which is connected to the friction lining so that it rotates about a fulcrum, in that the friction lining and the second friction lining run at least partially around the periphery of the piston, and engages on its side facing the piston in a peripheral groove of the same, in that the memory metal part acts on the support part and a second support part, and in that end regions of the support part and the second support part facing away from the fulcrum are spread apart by the recuperating spring.

6. The friction damper device of claim 5, wherein the memory metal part is a rod-shaped part running through a through opening running transversely through the piston, which part is fastened with one end to the support part and with another end to the second support part.

7. The friction damper device of claim 6, wherein the memory metal part is formed by a metal wire.

8. The friction damper device of claim 5, wherein the memory metal part takes a form of a memory wire which is formed into a loop and, when energized, reduces a circumference of the loop, and in that the loop runs around a roll arranged in the piston and fastened to the support part, and is fastened on the side opposite the roll to the second support part.

9. The friction damper device of claim 5, wherein the at least one friction lining acts directly on the piston rod of the damper, is pretensed counter to the piston rod by the energy store, and can be displaced away from the piston rod by activating the actuator.

10. A washing machine comprising:
a housing having a frame;
a washing unit disposed within the housing and including a tub;
a washing drum rotationally mounted in the tub and a drive for rotating the washing drum;
a damper at least partially supporting the washing unit in an elastic manner against the frame of the housing, the damper including a piston and piston rod arranged in a cylinder; and
a friction damper device comprising:
at least one friction lining acting directly on an inner wall of the cylinder of the damper, wherein the at least one friction lining is pretensed counter to the inner wall of the cylinder of the damper by an energy store and can be displaced away from the inner wall of the cylinder by activating an actuator.
